(19) United States
(12) Patent Application Publication
(10) Pub. No.: US 2025/0182976 A1
(43) Pub. Date: Jun. 5, 2025

(54) ELECTROLYTIC CAPACITOR AND METHOD FOR PRODUCING ELECTROLYTIC CAPACITOR

(71) Applicant: Panasonic Intellectual Property Management Co., Ltd., Osaka (JP)

(72) Inventors: Tatsuji AOYAMA, KYOTO FU (JP); Shumpei MATSUSHITA, YAMAGUCHI KEN (JP); Tomoyuki TASHIRO, YAMAGUCHI KEN (JP)

(21) Appl. No.: 18/832,160

(22) PCT Filed: Jan. 27, 2023
(86) PCT No.: PCT/JP2023/002686

§ 371 Date: Jul. 23, 2024

(30) Foreign Application Priority Data
Jan. 28, 2022 (JP) 2022-012068

(51) Int. Cl. H01G 9/028; H01G 9/02; H01G 9/055; H01G 9/15; H01G 13/04

(52) U.S. Cl. CPC H01G 9/028; H01G 9/02; H01G 9/055; H01G 9/151; H01G 13/04

(57) ABSTRACT

A disclosed manufacturing method includes, in the following order: a polymer layer formation step of forming a conductive polymer layer containing a conductive polymer component; a stacked body formation step of forming a stacked body including the conductive polymer layer by stacking an anode foil, a cathode foil, and a separator such that the separator is disposed between the anode foil and the cathode foil; and an impregnation step of impregnating the stacked body with a liquid component. The polymer layer formation step includes: a step (a) of applying an application liquid containing the conductive polymer component and a liquid medium to a predetermined surface and the separator; and a step (b) of forming the conductive polymer layer on the predetermined surface and the separator by removing a portion of the liquid medium from the applied application liquid. The liquid medium includes water and an organic compound that does not boil at 100° C. under 1 atm. In the step (b), a portion of the liquid medium is removed such that the organic compound remains in the conductive polymer layer.

### TECHNICAL FIELD

The present disclosure relates to an electrolytic capacitor and a method for manufacturing an electrolytic capacitor.

### BACKGROUND ART

An electrolytic capacitor that includes a wound body including an anode foil, a separator, and a cathode foil is known. An example of such an electrolytic capacitor includes a conductive polymer layer disposed inside the wound body. The conductive polymer layer is formed by impregnating the wound body with a dispersion liquid that contains particles of a conductive polymer, for example.

The dispersion liquid containing particles of a conductive polymer has high viscosity due to containing the particles. Accordingly, even if the wound body is impregnated with the dispersion liquid, it may not be possible to form the conductive polymer layer sufficiently inside the wound body. Insufficient formation of the conductive polymer layer may result in a reduction in an initial capacity, an increase in the equivalent series resistance (ESR), and a reduction in the reliability, for example. Also, if a dielectric film formed on a surface of the anode foil is covered by dense conductive polymer particles, an electrolyte solution is unlikely to come into contact with a surface of the dielectric layer. Consequently, the electrolyte solution does not sufficiently function to form a dielectric layer (oxide film), and this may result in an increase of a leakage current or the occurrence of a short circuit, for example.

PTL 1 (International Publication WO 2020/158780) discloses “a method for producing an electrolytic capacitor, the method including steps of: preparing an electrode foil; preparing a first conductive polymer dispersion containing a first conductive polymer component and a first dispersion medium; forming a first conductive polymer layer containing the first conductive polymer component by applying the first conductive polymer dispersion to a surface of the electrode foil by a coating method, and then at least partially removing the first dispersion medium; and fabricating a capacitor element using the electrode foil having the first conductive polymer layer.”

PTL 2 (International Publication WO 2020/158783) discloses “a method for producing an electrolytic capacitor, the method including steps of: preparing an anode foil that includes a dielectric layer, a cathode foil, and a fiber structure; preparing a conductive polymer dispersion liquid that contains a conductive polymer component and a dispersion medium; producing a separator by applying the conductive polymer dispersion liquid to the fiber structure and then removing at least a portion of the dispersion medium; and producing a capacitor element by sequentially stacking the anode foil, the separator, and the cathode foil, wherein the dispersion medium contains water, the fiber structure contains a synthetic fiber in an amount of 50% by mass or more, and the fiber structure has a density of 0.2 g/cm³ or more and less than 0.45 g/cm³.”

### CITATION LIST

### Patent Literature

PTL 1: International Publication WO 2020/158780
PTL 2: International Publication WO 2020/158783

### SUMMARY OF INVENTION

### Technical Problem

An object of the present disclosure is to provide a method for manufacturing an electrolytic capacitor that includes a conductive polymer layer and has excellent characteristics.

### Solution to Problem

A first aspect of the present disclosure relates to a method for manufacturing an electrolytic capacitor. The method is a method for manufacturing an electrolytic capacitor including an anode foil having a dielectric layer formed on a surface thereof, a cathode foil, and a separator, and the method includes, in the following order: a polymer layer formation step of forming a conductive polymer layer containing a conductive polymer component on the separator and at least one surface selected from a surface of the dielectric layer and a surface of the cathode foil; a stacked body formation step of forming a stacked body including the conductive polymer layer by stacking the anode foil, the cathode foil, and the separator such that the separator is disposed between the anode foil and the cathode foil; and an impregnation step of impregnating the stacked body with a liquid component, wherein the polymer layer formation step includes: a step (a) of applying an application liquid containing the conductive polymer component and a liquid medium to the at least one surface and the separator; and a step (b) of forming the conductive polymer layer on the at least one surface and the separator by removing a portion of the liquid medium from the applied application liquid, the liquid medium includes water and an organic compound that does not boil at 100° C. under 1 atm, and in the step (b), a portion of the liquid medium is removed such that the organic compound remains in the conductive polymer layer.

Another aspect of the present disclosure relates to an electrolytic capacitor. The electrolytic capacitor includes: a stacked body including an anode foil having a dielectric layer formed on a surface thereof, a cathode foil, and a separator; and a liquid component with which the stacked body is impregnated, wherein the stacked body includes a conductive polymer layer formed on the separator and at least one surface selected from a surface of the dielectric layer and a surface of the cathode foil, the conductive polymer layer includes a mixed region in which a first conductive polymer layer formed on the at least one surface and a second conductive polymer layer formed on the separator are mixed, and an organic compound that does not boil at 100° C. under 1 atm is present in the conductive polymer layer.

### Advantageous Effects of Invention

According to the present disclosure, it is possible to obtain an electrolytic capacitor that includes a conductive polymer layer and has excellent characteristics.

While novel features of the present invention are set forth in the appended claims, both the configuration and content of the present invention, as well as other objects and features of the present invention, will be better understood from the following detailed description given with reference to the drawings.

### BRIEF DESCRIPTION OF DRAWINGS

FIG. 1 is a side view schematically showing an electrolytic capacitor according to an embodiment of the present disclosure.

FIG. 2 is an exploded perspective view schematically showing a capacitor element according to an embodiment of the present disclosure.

### DESCRIPTION OF EMBODIMENTS

The following describes an example embodiment of the present invention, but the present invention is not limited to the following example. In the following description, specific numerical values and materials are given as examples in some cases, but other numerical values and other materials may also be applied as long as the invention according to the present disclosure can be implemented. In the specification, the expression “a numerical value A to a numerical value B” includes the numerical value A and the numerical value B, and can be read as “the numerical value A or more and the numerical value B or less”. In the following description, if lower and upper limits of numerical values regarding specific physical properties or conditions are exemplified, any of the exemplified lower limits and any of the exemplified upper limits can be combined as desired as long as the lower limit is not equal to or greater than the upper limit.

### (Method for Manufacturing Electrolytic Capacitor)

A manufacturing method according to an embodiment of the present disclosure is a method for manufacturing an electrolytic capacitor including an anode foil having a dielectric layer formed on a surface thereof, a cathode foil, and a separator. Hereinafter, the manufacturing method may also be referred to as a “manufacturing method (M)”. The manufacturing method (M) includes a polymer layer formation step, a stacked body formation step, and an impregnation step in this order. The following describes these steps.

### (Polymer Layer Formation Step)

The polymer layer formation step is a step of forming a conductive polymer layer that contains a conductive polymer component on the separator and at least one surface selected from a surface of the dielectric layer (the dielectric layer on the surface of the anode foil) and a surface of the cathode foil. Hereinafter, the at least one surface may be referred to as “at least one surface (S)” or “surface (S)”.

The polymer layer formation step includes a step (a) and a step (b). The step (a) is a step of applying an application liquid that contains the conductive polymer component and a liquid medium to the at least one surface (S) and the separator. The step (b) is a step of forming the conductive polymer layer on the at least one surface (S) and the separator by removing a portion of the liquid medium from the applied application liquid. The liquid medium includes water and an organic compound that does not boil at 100° C. under 1 atm (101325 Pa). In the step (b), a portion of the liquid medium is removed such that the organic compound remains in the conductive polymer layer. The following describes the steps (a) and (b).

In the step (a), the application liquid may be applied to a surface of the dielectric layer and the separator or may be applied to a surface of the cathode foil and the separator. Alternatively, the application liquid may be applied to a surface of the dielectric layer, a surface of the cathode foil, and the separator. As necessary, the application liquid is applied to dielectric layers formed on both surfaces of the anode foil and applied to both surfaces of the cathode foil. A conductive polymer layer is formed in regions to which the application liquid is applied.

Examples of the conductive polymer component will be described later. The conductive polymer component may be dispersed in the state of particles in the application liquid. The liquid medium includes water and the organic compound that does not boil at 100° C. under 1 atm. Hereinafter, the organic compound may also be referred to as an “organic compound (C)”. The organic compound (C) may be constituted of a single compound or a plurality of compounds. Accordingly, the term “organic compound (C)” can be read as “at least one organic compound”.

Water boils and evaporates at about 100° C. under 1 atm. On the other hand, the organic compound (C) does not boil at 100° C. under 1 atm. Therefore, by heating the application liquid at a temperature at which the organic compound (C) does not boil and decompose and that is higher than or equal to 100° C., it is possible to remove water from the application liquid while leaving the organic compound (C) in the application liquid. Consequently, the organic compound (C) remains in the conductive polymer layer that is formed. If the organic compound (C) does not remain in the conductive polymer layer, the conductive polymer layer shrinks significantly when the liquid medium is removed from the application liquid. In this case, a liquid component (e.g., an electrolyte solution) is unlikely to permeate the conductive polymer layer in the following impregnation step. Consequently, the liquid component does not sufficiently function to form a dielectric layer (oxide film), and this may result in an increase of a leakage current or the occurrence of a short circuit, for example.

In the step (b) of the manufacturing method (M) according to the present embodiment, a portion of the liquid medium is removed such that the organic compound (C) remains in the conductive polymer layer. Therefore, it is possible to suppress excessive shrinkage of the formed conductive polymer layer and enhance impregnation with the liquid component. As a result, according to the manufacturing method (M), it is possible to manufacture an electrolytic capacitor that includes the conductive polymer layer and has excellent characteristics.

There is no limitation on the method for applying the application liquid, and a known method may be used to apply the application liquid. For example, a method that uses a coater may be used, the application liquid may be sprayed, or an object to which the application liquid is to be applied may be immersed in the application liquid. Examples of the method that uses a coater include a gravure coating method and a die coating method. Note that methods for applying the application liquid to the separator include a method of impregnating the separator with the application liquid. The application liquid applied to the separator permeates the inside of the separator, and the conductive polymer layer can be formed in an entire region of the separator in its thickness direction.

There is no limitation on the method for removing the liquid medium from the application liquid as long as a portion of the liquid medium can be removed such that the organic compound (C) remains in the conductive polymer layer. The liquid medium may be removed through heating and/or by reducing a pressure, and it is preferable to perform at least heating.

When heating is performed, it is preferable to remove a portion of the liquid medium by heating the applied application liquid at a temperature higher than or equal to 100° C. When the application liquid is heated at a temperature higher than or equal to 100° C., it is possible to rapidly remove water included in the liquid medium. The heating temperature is preferably a temperature at which the organic compound (C) does not boil and decompose. If the organic compound (C) does not have a definite boiling point, it is preferable to heat the application liquid at a temperature at which the organic compound (C) does not evaporate very much and does not decompose. The heating temperature may be 100° C. or higher, 120° C. or higher, or 140° C. or higher, and may be 200° C. or lower, or 160° C. or lower. The heating temperature may be within a range from 100° C. to 200° C. The heating time is not particularly limited as long as a portion of the liquid medium can be removed appropriately. For example, the heating time is within a range from 5 to 60 minutes.

In the formation of the conductive polymer layer on a single member, the step (b) may be performed by heating the member twice or more times at a temperature within a predetermined range (e.g., a temperature within a range from 100° C. to 200° C.). For example, in the formation of the conductive polymer layer on dielectric layers formed on both surfaces of the anode foil, heating may be performed after the application liquid is applied to a surface, and heating may be performed after the application liquid is applied to another surface. A similar method can also be applied to the case where the conductive polymer layer is formed on both surfaces of the cathode foil.

Note that the conductive polymer layer can be formed separately on each member. Accordingly, the application liquid may be applied to a member (step (a)) after another member is dried (step (b)). For example, after the application liquid is applied to the surface (S) (step (a)) and the surface (S) is dried (step (b)), the application liquid may be applied to the separator (step (a)) and the separator may be dried (step (b)). Likewise, the steps (a) and (b) for forming the conductive polymer layer on the anode foil (on the dielectric layer), the steps (a) and (b) for forming the conductive polymer layer on the cathode foil, and the steps (a) and (b) for forming the conductive polymer layer on the separator can be performed in a suitable order.

In a preferred example of the manufacturing method (M), the water content in the application liquid is 40% by mass or more (e.g., 50% by mass or more), and the steps (a) and (b) are performed such that the mass of the organic compound (C) contained in the conductive polymer layer is larger than the mass of water contained in the conductive polymer layer.

In the step (b), a ratio Ww/Wc between the mass Ww of water contained in the conductive polymer layer and the mass Wc of the organic compound (C) contained in the conductive polymer layer may be 0 or more, or 0.1 or more, and may be 0.9 or less, or 0.95 or less. Wc can be measured using a method described later. Ww can be measured using Karl Fischer titration.

The steps (a) and (b) may also be performed such that a ratio Wc/Wp between the mass Wc of the organic compound (C) remaining in the conductive polymer layer and a mass Wp of the conductive polymer component contained in the conductive polymer layer is 1.0 or more and 20 or less. The ratio Wc/Wp may be 1.0 or more, 1.2 or more, or 2.0 or more, and may be 20 or less, 12 or less, or 10 or less. The ratio Wc/Wp may be 1.0 or more and 10 or less, 1.2 or more and 10 or less, or 2.0 or more and 10 or less. When the ratio Wc/Wp is 2.0 or more and 10 or less, it is possible to obtain an electrolytic capacitor that has particularly excellent characteristics. Methods for measuring Wc and Wp will be described later.

In the polymer layer formation step, the conductive polymer layer may be formed on the surface of the dielectric layer, the surface of the cathode foil, and the separator. According to this configuration, the conductive polymer layer can be formed in such a manner as to be continuous from the dielectric layer to the cathode foil facing the dielectric layer.

In the following description, the conductive polymer layer formed on the surface (S) may be referred to as a “first conductive polymer layer”, and the conductive polymer layer formed on the separator may be referred to as a “second conductive polymer layer”. The second conductive polymer layer can be formed on a surface of fibers or a microporous film constituting the separator.

The first conductive polymer layer and the second conductive polymer layer may be constituted of the same conductive polymer component or may contain different conductive polymer components. The first conductive polymer layer formed on the anode foil (on the dielectric layer), the first conductive polymer layer formed on the cathode foil, and the second conductive polymer layer may be constituted of the same conductive polymer component or may contain different conductive polymer components. In a preferred example, these layers contain the same conductive polymer component.

When the first conductive polymer layer is formed on a surface of the anode foil (or the cathode foil), it is preferable to form the first conductive polymer layer in 80% or more (e.g., 90% or more) of the area of the surface on which the first conductive polymer layer is formed. The first conductive polymer layer is preferably formed on an entire surface of the electrode foil (the anode foil or the cathode foil) that contributes to the capacitance of a capacitor element, out of surfaces of the electrode foil. The area of the second conductive polymer layer formed on the separator is preferably 80% or more (e.g., 90% or more) of the area of the separator, and the second conductive polymer layer may be formed on the entire separator. Here, the area of a surface of an electrode foil (the anode foil or the cathode foil) is an area calculated without irregularities in the surface being taken into account, and can be calculated from an external shape of the electrode foil. When the first conductive polymer is formed on both surfaces of an electrode foil, the area of the surfaces on which the first conductive polymer is formed is the sum of the areas of both surfaces.

The mass of the first conductive polymer layer per unit area may be 0.01 mg/cm² or more, or 0.02 mg/cm² or more, and may be 0.5 mg/cm² or less, or 0.3 mg/cm² or less. When the mass is 0.1 mg/cm² or more, the conductive polymer layer can be formed more uniformly. Note that, when the first conductive polymer layer is formed on both surfaces of an electrode foil, the above-described mass per unit area is the mass of the first conductive polymer layer formed on a surface of the electrode foil.

The mass of the second conductive polymer layer per unit area may be 0.02 mg/cm² or more, or 0.05 mg/cm² or more, and may be 2.0 mg/cm² or less, or 1.0 mg/cm² or less. When the mass is 0.3 mg/cm² or more, the conductive polymer layer can be formed more uniformly.

Note that the mass of the conductive polymer layer per unit area can be calculated using the following method. First, five samples each having a predetermined area are cut out from the member (the electrode foil or the separator) prior to the formation of the conductive polymer layer, and masses of the five samples are measured. Also, five samples each having the predetermined area are cut out from the member (the electrode foil or the separator) on which the conductive polymer layer has been formed, and masses of the samples are measured. The mass of the conductive polymer layer per unit area is calculated from the predetermined area and a difference between a sum of the masses of the five samples after the formation of the conductive polymer layer and a sum of the masses of the five samples prior to the formation of the conductive polymer layer.

### (Stacked Body Formation Step)

The stacked body formation step is a step of forming a stacked body including the conductive polymer layer by stacking the anode foil, the cathode foil, and the separator such that the separator is disposed between the anode foil and the cathode foil.

There is no limitation on the method for forming the stacked body, and a known method may be used to form the stacked body. The stacked body may be a wound body. In this case, the wound body may be formed by winding together the anode foil, the cathode foil, and the separator such that the separator is disposed between the anode foil and the cathode foil in the stacked body formation step. In the wound body, the anode foil, the cathode foil, and the separator are stacked in a radial direction of the wound body.

The stacked body may be formed by stacking a flat anode foil, a flat cathode foil, and a flat separator in one direction. For example, it is also possible to form the stacked body by stacking a plurality of anode foils, a plurality of cathode foils, and a plurality of separators in one direction. In a typical example of such a stacked body, the anode foils and the cathode foils are alternately disposed, and the separators are disposed between the anode foils and the cathode foils.

### (Impregnation Step)

The impregnation step is a step of impregnating the stacked body formed in the stacked body formation step with a liquid component. Hereinafter, the liquid component may also be referred to as a “liquid component (L)”. There is no limitation on the method for impregnating the stacked body with the liquid component (L). For example, the stacked body may be impregnated with the liquid component (L) by immersing at least a portion of the stacked body in the liquid component (L). Examples of the liquid component (L) will be described later.

Through the steps described above, a capacitor element including the conductive polymer layer and the liquid component is formed. Thereafter, the capacitor element is enclosed in an exterior body as necessary. Thus, an electrolytic capacitor is manufactured. Note that the manufacturing method (M) may also include a step other than the above-described steps as necessary.

The conductive polymer layer may include the first conductive polymer layer formed on the at least one surface (S) described above and the second conductive polymer layer formed on the separator. In this case, the conductive polymer layer in the stacked body subjected to the impregnation step may include a mixed region in which the first conductive polymer layer and the second conductive polymer layer are mixed.

In the conductive polymer layer formation step of the manufacturing method (M), the liquid medium of the application liquid is removed such that the organic compound (C) remains in the conductive polymer layer. Therefore, excessive shrinkage of the conductive polymer component is suppressed, and it is possible to form the mixed region in which the first conductive polymer layer and the second conductive polymer layer are mixed. It is possible to reduce the ESR of the capacitor element by forming the mixed region.

### (Application Liquid)

The application liquid used in the polymer layer formation step contains the conductive polymer component, water, and the organic compound (C) as described above. The application liquid may also contain another component as necessary. An organic compound that dissolves well in water can be preferably used as the organic compound (C). The organic compound (C) may be a compound that is miscible with water. Examples of the organic compound (C) include compounds that are used as organic solvents. Examples of the organic compound (C) include polyhydric alcohols that have two or more hydroxyl groups. Water in which the organic compound (C) has dissolved can be used as a dispersion medium of the conductive polymer component. From a standpoint, the application liquid is a dispersion liquid in which particles of the conductive polymer component are dispersed, and the dispersion medium of the dispersion liquid is water in which the organic compound (C) has dissolved.

Examples of the organic compound (C) include polyhydric alcohols, sulfolane, γ-butyrolactone, and borate esters. The organic compound (C) may include at least one selected from the group consisting of polyhydric alcohols, sulfolane, γ-butyrolactone, and borate esters, and may also be at least one selected from the group. The organic compound (C) may include at least one selected from the group consisting of glycols, glycerins, sugar alcohols, sulfolane, γ-butyrolactone, and borate esters, and may also be at least one selected from the group.

Examples of the polyhydric alcohols include glycols, glycerins, and sugar alcohols. Examples of the glycols include ethylene glycol, diethylene glycol, triethylene glycol, polyalkylene glycol (e.g., polyethylene glycol), and polyoxyethylene polyoxypropylene glycol (ethylene oxide-propylene oxide copolymer). Examples of the glycerins include glycerin and polyglycerins. Examples of the sugar alcohols include mannitol, xylitol, sorbitol, erythritol, and pentaerythritol.

In the present specification, the term “boiling point” means a boiling point under 1 atm unless otherwise stated. Examples of the organic compound (C) include organic compounds that have a boiling point higher than 100° C. When the organic compound (C) has a boiling point, the boiling point may be 110° C. or higher, 150° C. or higher, or 200° C. or higher, and may be 400° C. or lower, 300° C. or lower, 250° C. or lower, or 200° C. or lower. The boiling point may be within a range from 110° C. to 400° C. (e.g., from 150° C. to 350° C.).

The conductive polymer component includes a conductive polymer, and may be constituted of only the conductive polymer. Alternatively, the conductive polymer component may include a conductive polymer and a dopant.

Examples of the conductive polymer include polypyrrole, polythiophene, polyfuran, polyaniline, polyacetylene, and derivatives thereof. Examples of the derivatives include polymers that include polypyrrole, polythiophene, polyfuran, polyaniline, or polyacetylene as the basic skeleton. Examples of derivatives of polythiophene include poly(3,4-ethylenedioxythiophene). Any one of these conductive polymers may be used alone, or two or more of these may be used in combination. Also, the conductive polymer may be a copolymer of two or more monomers. The weight average molecular weight of the conductive polymer is not particularly limited, and may be within a range from 1000 to 100000, for example. A preferred example of the conductive polymer is poly(3,4-ethylenedioxythiophene) (PEDOT).

The conductive polymer may be doped with a dopant. From the standpoint of suppressing de-doping from the conductive polymer, it is preferable to use a polymer dopant as the dopant. Examples of the polymer dopant include polyvinyl sulfonic acid, polystyrene sulfonic acid, polyallyl sulfonic acid, polyacryl sulfonic acid, polymethacryl sulfonic acid, poly(2-acrylamido-2-methylpropanesulfonic acid), polyisoprene sulfonic acid, and polyacrylic acid. Any one of these may be used alone, or two or more of these may be used in combination. At least some of these may be added in the form of a salt. A preferred example of the dopant is polystyrene sulfonic acid (PSS).

In the electrolytic capacitor according to the present disclosure, the dopant may be a dopant that contains an acidic group or a polymer dopant that contains an acidic group. Examples of the acidic group include a sulfonic acid group and a carboxyl group. The polymer dopant containing an acidic group is a polymer in which at least some constituent units contain an acidic group. Examples of such a polymer dopant include the polymer dopants described above.

The weight average molecular weight of the dopant is not particularly limited. From the standpoint of facilitating formation of a uniform conductive polymer layer, the weight average molecular weight of the dopant may be within a range from 1000 to 100000.

The dopant may be polystyrene sulfonic acid, and the conductive polymer may be poly(3,4-ethylenedioxythiophene). That is to say, the conductive polymer component may be poly(3,4-ethylenedioxythiophene) doped with polystyrene sulfonic acid.

When the conductive polymer doped with the dopant is used, the pH of the application liquid is preferably less than 7.0 in order to suppress de-doping of the dopant, and may be 6.0 or less, or 5.0 or less. The pH of the application liquid may be 1.0 or more, or 2.0 or more.

The conductive polymer component may be present in the state of particles in the application liquid. In a particle size distribution of the particles of the conductive polymer component on the volume basis, the mode of the particle size may be 10 nm or more, or 20 nm or more, and may be 1000 nm or less, 500 nm or less, 200 nm or less, or 100 nm or less. The particle size distribution on the volume basis can be determined with use of a laser diffraction/scattering particle size distribution measurement device.

The above-described mode of the particle size of the particles of the conductive polymer component may be within a range from 20 nm to 200 nm (e.g., from 20 nm to 100 nm). In the particle size distribution on the volume basis, the percentage of particles having a particle size within a range from 20 nm to 100 nm may be 90% or more of all the particles on the volume basis. When the mode and the percentage are within these ranges, it is easy to form the conductive polymer layer containing the conductive polymer component in pores of the members (the electrode foil and the separator).

The water content in the application liquid may be 40% by mass or more, 50% by mass or more, 70% by mass or more, 73% by mass or more, 78% by mass or more, 80% by mass or more, 88% by mass or more, 90% by mass or more, or 95% by mass or more. The content may be 98% by mass or less, 95% by mass or less, 90% by mass or less, or 80% by mass or less. The content may be 40 to 98% by mass or more, or within a range from 50 to 98% by mass, a range from 80 to 98% by mass, or a range from 70 to 98% by mass. The upper limit of any of these ranges may be replaced with 95% by mass, 90% by mass, or 80% by mass.

The content of the organic compound (C) in the application liquid may be 1.0% by mass or more, 3.0% by mass or more, 5.0% by mass or more, or 10% by mass or more. The content may be 59.5% by mass or less, 45% by mass or less, 30% by mass or less, 25% by mass or less, 20% by mass or less, 15% by mass or less, or 10% by mass or less. The content may be within a range from 1 to 59.5% by mass, a range from 3 to 59.5% by mass, or a range from 5 to 59.5% by mass. The upper limit of any of these ranges may be replaced with 45% by mass, 30% by mass, 25% by mass, 20% by mass, 15% by mass, or 10% by mass.

The content of the conductive polymer component in the application liquid may be 0.5% by mass or more, or 1.0% by mass or more, and may be 4.0% by mass or less, 3.0% by mass or less, or 2.0% by mass or less. The content may be within a range from 0.5 to 4.0% by mass or a range from 1.0 to 4.0% by mass. The upper limit of any of these ranges may be replaced with 3.0% by mass or 2.0% by mass. The content is preferably within a range from 1.0 to 3.0% in terms of achieving excellent physical properties of the application liquid, excellent stability of the physical properties over time, and a good balance between the ESR of the electrolytic capacitor and the cost. When the application liquid contains a dopant, the mass of the dopant is included in the mass of the conductive polymer component.

The mass of the dopant contained in the application liquid is not particularly limited, and may be within a range from 0.1 to 5 times (e.g., from 0.5 to 3 times) the mass of the conductive polymer contained in the application liquid.

A ratio between the water content, the content of the organic compound (C), and the content of the conductive polymer component in the application liquid may be 40 to 98:1.0 to 59.5:0.5 to 4.0, and the ratio between the water content, the content of the organic compound (C), and the content of the conductive polymer component may also be 69.5 to 98:1.0 to 30:0.5 to 4.0.

The water content, the content of the organic compound (C), and the content of the conductive polymer component described above can be combined suitably unless no contradiction arises. An example of the application liquid may satisfy one, two, three, or four conditions suitably selected from the following conditions (1) to (5) or satisfy all the conditions.
(1) The water content is within a range from 50 to 98% by mass (e.g., from 73 to 95% by mass), the content of the organic compound (C) is within a range from 3 to 30% by mass (e.g., from 5 to 25% by mass), and the content of the conductive polymer component is within a range from 0.5 to 4.0% by mass (e.g., from 1.0 to 3.0% by mass).
(2) The organic compound (C) is a glycol (e.g., ethylene glycol).
(3) The conductive polymer component includes poly(3,4-ethylenedioxythiophene) and polystyrene sulfonic acid. For example, the conductive polymer component may be constituted of poly(3,4-ethylenedioxythiophene) and polystyrene sulfonic acid.
(4) The pH of the application liquid is within a range from 1.0 to 6.0 (e.g., from 2.0 to 5.0).
(5) The conductive polymer component is present in the state of particles in the application liquid, and in the particle size distribution of the particles of the conductive polymer component on the volume basis, the mode of the particle size is within a range from 20 nm to 1000 nm (e.g., from 20 nm to 200 nm or from 20 nm to 100 nm). In the particle size distribution on the volume basis, the percentage (on the volume basis) of particles having a particle size within the range from 20 nm to 1000 nm (e.g., from 20 nm to 200 nm or from 20 nm to 100 nm) may be 90% or more of all the particles.

The application liquid may satisfy the conditions (3) and (4) described above. When the conditions (3) and (4) are satisfied, it is possible to form a conductive polymer layer that has high conductivity.

### (Liquid Component (L))

Examples of the liquid component (L) used in the impregnation step include a nonaqueous solvent and an electrolyte solution. It is possible to use an electrolyte solution that contains a nonaqueous solvent and a solute dissolved in the nonaqueous solvent. In the present specification, the liquid component (L) may be a component that is liquid at room temperature (25° C.) or a component that is liquid at a temperature at which the electrolytic capacitor is used.

The nonaqueous solvent used in the liquid component (L) may be an organic solvent, an ionic liquid, or a protic solvent. Examples of the nonaqueous solvent include polyhydric alcohols such as ethylene glycol and propylene glycol, cyclic sulfones such as sulfolane (SL), lactones such as γ-butyrolactone (γBL), amides such as N-methylacetamide, N,N-dimethylformamide, and N-methyl-2-pyrrolidone, esters such as methyl acetate, carbonate compounds such as propylene carbonate, ethers such as 1,4-dioxane, ketones such as methyl ethyl ketone, and formaldehyde.

It is also possible to use a polymer-based solvent as the nonaqueous solvent. Examples of the polymer-based solvent include polyalkylene glycol, derivatives of polyalkylene glycol, and compounds in which at least one hydroxyl group of a polyhydric alcohol is substituted with polyalkylene glycol (including derivatives thereof). Specific examples of the polymer-based solvent include polyethylene glycol (PEG), polyethylene glycol glyceryl ether, polyethylene glycol diglyceryl ether, polyethylene glycol sorbitol ether, polypropylene glycol, polypropylene glycol glyceryl ether, polypropylene glycol diglyceryl ether, polypropylene glycol sorbitol ether, and polybutylene glycol. Examples of the polymer-based solvent further include ethylene glycol-propylene glycol copolymer, ethylene glycol-butylene glycol copolymer, and propylene glycol-butylene glycol copolymer. A nonaqueous solvent may be used alone, or a mixture of two or more nonaqueous solvents may be used.

The liquid component (L) may contain the nonaqueous solvent and a base component (base) dissolved in the nonaqueous solvent. Also, the liquid component (L) may contain the nonaqueous solvent and a base component and/or an acid component (acid) dissolved in the nonaqueous solvent.

As the acid component, it is possible to use a polycarboxylic acid and a monocarboxylic acid. Examples of the polycarboxylic acid include aliphatic polycarboxylic acid ([saturated polycarboxylic acid such as oxalic acid, malonic acid, succinic acid, glutaric acid, adipic acid, pimelic acid, suberic acid, azelaic acid, sebacic acid, 1,6-decanedicarboxylic acid, and 5,6-decanedicarboxylic acid]; [unsaturated polycarboxylic acid such as maleic acid, fumaric acid, and itaconic acid]), aromatic polycarboxylic acid (e.g., phthalic acid, isophthalic acid, terephthalic acid, trimellitic acid, and pyromellitic acid), alicyclic polycarboxylic acid (e.g., cyclohexane-1,2-dicarboxylic acid and cyclohexene-1,2-dicarboxylic acid).

Examples of the monocarboxylic acid include aliphatic monocarboxylic acid (having 1 to 30 carbon atoms) ([saturated monocarboxylic acid such as formic acid, acetic acid, propionic acid, butyric acid, isobutyric acid, valeric acid, caproic acid, enanthic acid, caprylic acid, pelargonic acid, lauryl acid, myristic acid, stearic acid, and behenic acid]; [unsaturated monocarboxylic acid such as acrylic acid, methacrylic acid, and oleic acid]), aromatic monocarboxylic acid (e.g., benzoic acid, cinnamic acid, and naphthoic acid), and oxycarbonic acid (e.g., salicylic acid, mandelic acid, and resorcinol acid).

Among these, maleic acid, phthalic acid, benzoic acid, pyromellitic acid, and resorcinol acid are thermally stable and preferably used.

An inorganic acid may also be used as the acid component. Representative examples of the inorganic acid include phosphoric acid, phosphorous acid, hypophosphorous acid, alkyl phosphate, boric acid, borofluoric acid, tetrafluoroboric acid, hexafluorophosphoric acid, benzenesulfonic acid, and naphthalenesulfonic acid. It is also possible to use a composite compound of an organic acid and an inorganic acid as the acid component. Examples of such a composite compound include borodiglycolic acid, borodisuccinic acid, and borodisalicylic acid.

The base component may be a compound that has an alkyl-substituted amidine group such as imidazole compound, benzoimidazole compound, or alicyclic amidine compound (pyrimidine compound or imidazoline compound). Specifically, the base component is preferably 1,8-diazabicyclo[5,4,0]undecene-7, 1,5-diazabicyclo[4,3,0]nonene-5, 1,2-dimethylimidazolinium, 1,2,4-trimethylimidazoline, 1-methyl-2-ethyl-imidazoline, 1,4-dimethyl-2-ethylimidazoline, 1-methyl-2-heptylimidazoline, 1-methyl-2-(3′heptyl)imidazoline, 1-methyl-2-dodecylimidazoline, 1,2-dimethyl-1,4,5,6-tetrahydropyrimidine, 1-methylimidazole, or 1-methylbenzoimidazole. With use of these, it is possible to obtain a capacitor that has excellent impedance performance.

A quaternary salt of a compound that has an alkyl-substituted amidine group may also be used as the base component. Examples of such a base component include an imidazole compound, a benzoimidazole compound, and an alicyclic amidine compound (a pyrimidine compound or an imidazoline compound), which are quaternized by an alkyl group or arylalkyl group having 1 to 11 carbon atoms. Specifically, the base component is preferably 1-methyl-1,8-diazabicyclo[5,4,0]undecene-7, 1-methyl-1,5-diazabicyclo[4,3,0]nonene-5, 1,2,3-trimethylimidazolinium, 1,2,3,4-tetramethylimidazolinium, 1,2-dimethyl-3-ethyl-imidazolinium, 1,3,4-trimethyl-2-ethylimidazolinium, 1,3-dimethyl-2-heptylimidazolinium, 1,3-dimethyl-2-(3′heptyl)imidazolinium, 1,3-dimethyl-2-dodecylimidazolinium, 1,2,3-trimethyl-1,4,5,6-tetrahydropyrimidium, 1,3-dimethylimidazolium, 1-methyl-3-ethylimidazolium, or 1,3-dimethylbenzoimidazolium. With use of these, it is possible to obtain a capacitor that has excellent impedance performance.

It is also possible to use a tertiary amine as the base component. Examples of the tertiary amine include trialkylamines (e.g., trimethylamine, dimethylethylamine, methyldiethylamine, triethylamine, dimethyl-n-propylamine, dimethylisopropylamine, methylethyl-n-propylamine, methylethylisopropylamine, diethyl-n-propylamine, diethylisopropylamine, tri-n-propylamine, triisopropylamine, tri-n-butylamine, and tri-tert-butylamine), and phenyl group-containing amines (e.g., dimethylphenylamine, methylethylphenylamine, and diethylphenylamine). Among these, trialkylamines are preferable in terms of achieving high conductivity, and it is more preferable that the base component includes at least one selected from the group consisting of trimethylamine, dimethylethylamine, methyldiethylamine, and triethylamine. It is also possible to use secondary amines such as dialkylamines, primary amines such as monoalkylamine, or ammonia as the base component.

The liquid component (L) may contain a salt of an acid component and a base component. The salt may be an inorganic salt and/or an organic salt. An organic salt is a salt in which at least one of the anion and the cation contains an organic substance. For example, it is possible to use, as the organic salt, trimethylamine maleate, triethylamine borodisalicylate, ethyldimethylamine phthalate, mono-1,2,3,4-tetramethylimidazolinium phthalate, or mono-1,3-dimethyl-2-ethylimidazolinium phthalate.

In order to suppress de-doping of the dopant, the pH of the liquid component (L) may be less than 7.0, or 5.0 or less, and may be 1.0 or more, or 2.0 or more. The pH may be 1.0 or more and less than 7.0 (e.g., within a range from 2.0 to 5.0).

It is preferable that the liquid component (L) contains a protic solvent. When the liquid component (L) contains a protic solvent, a high effect can be obtained. The liquid component (L) may also contain a solvent other than the protic solvent, in addition to the protic solvent.

The protic solvent may include at least one selected from the group consisting of glycols, glycerin, polyglycerins, and sugar alcohols, and may also be at least one selected from the group. The protic solvent may be constituted of a single compound alone or may include a plurality of compounds.

The organic compound (C) and the liquid component (L) may include the same compound. For example, the organic compound (C) and the liquid component (L) may include the same polyhydric alcohol, the same glycol (e.g., ethylene glycol), or the same sugar alcohol.

The manufacturing method (M) may further include, after the stacked body formation step and before the impregnation step, a first step of impregnating the stacked body with a liquid that contains water as its major component and a second organic compound that does not boil at 100° C. under 1 atm and a second step of removing a portion of the liquid, with which the stacked body has been impregnated, such that the mass of the second organic compound contained in the stacked body is larger than the mass of water contained in the stacked body, and the first step and the second step are performed in this order. For example, the manufacturing method (M) may further include, after the stacked body formation step and before the impregnation step, a first step of impregnating the conductive polymer layer included in the stacked body with the liquid that contains water as its major component and the second organic compound that does not boil at 100° C. under 1 atm and a second step of removing a portion of the liquid, with which the conductive polymer layer has been impregnated, such that the mass of the second organic compound contained in the conductive polymer layer is larger than the mass of water contained in the conductive polymer layer, and the first step and the second step are performed in this order.

Here, the organic compound (C) described above will be referred to as a “first organic compound”. The first organic compound and the second organic compound may be the same as each other or different from each other. The compounds listed as examples of the organic compound (C) may be used as the second organic compound. It is possible to use, as the liquid used in the first step, the application liquid used in the polymer layer formation step or a liquid obtained by removing the conductive polymer component from the application liquid. The first step may be performed using the method described above regarding the step (a). The second step may be performed using the method described above regarding the step (b). It is possible to improve adhesion between the first conductive polymer layer and the second conductive polymer layer by performing the step of impregnating the conductive polymer layer with the liquid.

### (Electrolytic Capacitor)

Hereinafter, an electrolytic capacitor according to an embodiment of the present disclosure may be referred to as an “electrolytic capacitor (E)”. The electrolytic capacitor (E) can be manufactured using the manufacturing method (M). However, the electrolytic capacitor (E) may be manufactured using a method other than the manufacturing method (M). Matters described regarding the manufacturing method (M) can also be applied to the electrolytic capacitor (E), and therefore, redundant descriptions thereof may be omitted. Also, matters described regarding the electrolytic capacitor (E) may also be applied to the manufacturing method (M).

The electrolytic capacitor (E) includes: a stacked body including an anode foil having a dielectric layer formed on a surface thereof, a cathode foil, and a separator; and a liquid component with which the stacked body is impregnated. The liquid component is the liquid component (L) described above. The stacked body includes a conductive polymer layer that is formed on the separator and at least one surface (S) selected from a surface of the dielectric layer and a surface of the cathode foil. The conductive polymer layer includes a mixed region in which a first conductive polymer layer formed on the at least one surface (S) and a second conductive polymer layer formed on the separator are mixed. The conductive polymer layer (e.g., the mixed region) contains the organic compound (C) that does not boil at 100° C. under 1 atm.

The mixed region can be formed by manufacturing the electrolytic capacitor (E) using the manufacturing method (M). In this case, the organic compound (C) present in the mixed region is contained in the application liquid used in the step (a).

The electrolytic capacitor (E) includes the mixed region, and therefore, the ESR can be reduced. Also, the effects described above can be obtained by manufacturing the electrolytic capacitor (E) using the manufacturing method (M).

As described above, the organic compound (C) present in the mixed region may include at least one selected from the group consisting of polyhydric alcohols, sulfolane, γ-butyrolactone, and borate esters, and may also be at least one selected from the group.

The stacked body is impregnated with the liquid component (L). The electrolytic capacitor (E) may contain, in the stacked body (e.g., the mixed region), at least one selected from the group consisting of glycols, glycerin, polyglycerins, and sugar alcohols. This configuration improves the adhesion between the first conductive polymer layer and the second conductive polymer layer.

The following describes an example of the configuration and constituent elements of the electrolytic capacitor (E) manufactured using the manufacturing method (M). An example electrolytic capacitor described below includes a capacitor element, an exterior body, an anode lead terminal, and a cathode lead terminal. Note that the configuration and constituent elements of the electrolytic capacitor (E) are not limited to those in the following example.

The electrolytic capacitor (E) includes a stacked body and a liquid component (L) with which the stacked body is impregnated. The stacked body includes a conductive polymer layer. The stacked body functions as a capacitor element. The stacked body includes an anode foil having a dielectric layer formed on a surface thereof, a cathode foil, and a separator. The electrolytic capacitor (E) usually includes an exterior body in which the stacked body is enclosed.

### (Anode Foil)

Examples of the anode foil include metal foils containing at least one valve metal such as titanium, tantalum, aluminum, and niobium, and the anode foil may be a metal foil of a valve metal (for example, an aluminum foil). The anode foil may contain a valve metal in the form of an alloy containing the valve metal, a compound containing the valve metal, or the like. The thickness of the anode foil may be 15 μm or more and 300 μm or less. A surface of the anode foil may be roughened by etching or the like.

A dielectric layer is formed on the surface of the anode foil. The dielectric layer may be formed by subjecting the anode foil to chemical conversion treatment. In this case, the dielectric layer may contain an oxide of a valve metal (for example, an aluminum oxide). The dielectric layer only needs to function as a dielectric and may be formed of any dielectric other than an oxide of a valve metal.

The electrolytic capacitor may have a configuration in which the conductive polymer layer is not formed on edge surfaces of the anode foil. On the other hand, it is desirable that the dielectric layer is formed on the edge surfaces of the anode foil.

### (Cathode Foil)

The cathode foil is not particularly limited as long as it functions as a cathode. Examples of the cathode foil include a metal foil (for example, an aluminum foil). The type of the metal is not particularly limited, and the metal may be a valve metal or an alloy containing a valve metal. The thickness of the cathode foil may be 15 μm or more and 300 μm or less. A surface of the cathode foil may be roughened or subjected to chemical conversion treatment as necessary.

The cathode foil may include a conductive coating layer. When the metal foil used for the cathode foil contains a valve metal, the coating layer may contain carbon and at least one metal having a lower ionization tendency than the valve metal. This makes it easier to improve the acid resistance of the metal foil. When the metal foil contains aluminum, the coating layer may contain at least one selected from the group consisting of carbon, nickel, titanium, tantalum, and zirconium. In particular, nickel and/or titanium may be contained in the coating layer in terms of their low cost and low resistance.

The thickness of the coating layer may be 5 nm or more, or 10 nm or more, and may be 200 nm or less. The coating layer may be formed on the metal foil by vapor depositing or sputtering the above metal. Alternatively, the coating layer may be formed on the metal foil by vapor depositing a conductive carbon material or applying a carbon paste containing a conductive carbon material. Examples of the conductive carbon material include graphite, hard carbon, soft carbon, carbon black, and the like.

### (Separator)

A porous sheet can be used as the separator. Examples of the porous sheet include woven fabric, nonwoven fabric, and a microporous membrane. The thickness of the separator is not particularly limited and may be within a range from 10 to 300 μm. Examples of a material for the separator include cellulose, polyethylene terephthalate, polybutylene terephthalate, polyphenylene sulfide, vinylon, nylon, aromatic polyamide, polyimide, polyamide imide, polyetherimide, rayon, glass, and the like.

### (Exterior Body)

The exterior body includes a case and/or a sealing resin. There is no limitation on the case and the sealing resin, and it is possible to use a known case and a known sealing resin. The sealing resin may include a thermosetting resin. Examples of the thermosetting resin include epoxy resin, phenolic resin, silicone resin, melamine resin, urea resin, alkyd resin, polyurethane, polyimide, unsaturated polyester, and the like. The sealing resin may contain a filler, a curing agent, a polymerization initiator, and/or a catalyst, for example.

Hereinafter, an example of the present disclosure will be specifically described with reference to the drawings. The constituent elements described above can be applied to constituent elements of the following example. Also, the constituent elements of the following example can be modified based on the above description. Also, matters described below may be applied to the embodiment described above. In the following example, constituent elements that are not essential to the electrolytic capacitor according to the present disclosure may be omitted.

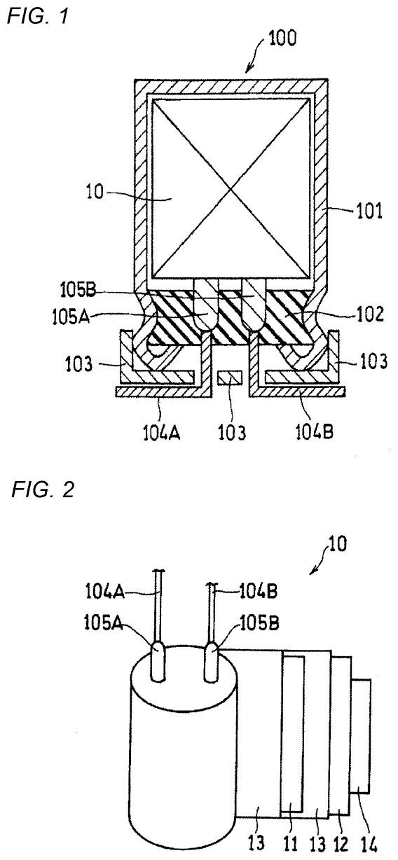

FIG. 1 is a cross-sectional view schematically showing an example of an electrolytic capacitor 100 according to the present embodiment. FIG. 2 is a schematic diagram in which a portion of a capacitor element 10 included in the electrolytic capacitor 100 is spread.

The electrolytic capacitor 100 includes the capacitor element 10, a bottomed case 101 in which the capacitor element 10 is housed, a sealing member 102 sealing an opening of the bottomed case 101, a base plate 103 covering the sealing member 102, lead wires 104A and 104B drawn out from the sealing member 102 and passing through the base plate 103, and lead tabs 105A and 105B connecting the lead wires and electrodes of the capacitor element 10. The vicinity of an open end of the bottomed case 101 is pressed inward through drawing, and the open end is curled so as to be swaged on the sealing member 102.

The capacitor element 10 is a wound body like that shown in FIG. 1, for example. The wound body includes an anode foil 11 connected to the lead tab 105A, a cathode foil 12 connected to the lead tab 105B, and a separator 13. The capacitor element 10 (wound body) includes a conductive polymer layer (not shown). The conductive polymer layer contains the organic compound (C). The electrolytic capacitor 100 includes the liquid component (L) (e.g., an electrolyte solution) with which the capacitor element 10 is impregnated.

The anode foil 11 and the cathode foil 12 are wound with the separator 13 disposed therebetween. The outermost turn of the wound body is fixed with a winding end tape 14. Note that FIG. 1 shows a state in which a portion of the wound body is spread before the outermost turn of the wound body is fixed.

The electrolytic capacitor only needs to include at least one capacitor element, and may include a plurality of capacitor elements. The number of capacitor elements included in the electrolytic capacitor can be determined depending on the application.

### Examples

The following describes the present disclosure more specifically based on examples, but the present disclosure is not limited to the examples. In the examples, a plurality of electrolytic capacitors were produced and evaluated using the following methods.

### (Capacitor A1)

An electrolytic capacitor (capacitor A1) was produced using the following method.

### (a) Preparation of Constituent Members

Surfaces of an aluminum foil (thickness: 100 μm) were roughened by performing etching on the aluminum foil. Dielectric layers were formed on the roughened surfaces of the aluminum foil by performing chemical conversion treatment. Thus, an anode foil having the dielectric layers on both surfaces thereof was obtained. Surfaces of an aluminum foil (thickness: 50 μm) were roughened by performing etching on the aluminum foil to obtain a cathode foil.

Nonwoven fabric (thickness: 50 μm) was prepared as a separator. The nonwoven fabric was constituted of 50% by mass of synthetic fibers (25% by mass of polyester fiber and 25% by mass of aramid fiber) and 50% by mass of cellulose, and contained polyacrylamide as a paper strength enhancing agent. The density of the nonwoven fabric was 0.35 g/cm³.

### (b) Preparation of Application Liquid

A dispersion liquid (commercially available product) in which particles of polyethylenedioxythiophene (PEDOT) doped with polystyrene sulfonic acid (PSS) were dispersed in water was prepared. An application liquid was obtained by adding ethylene glycol (organic compound (C)) and water to the dispersion liquid. The components were contained in the application liquid at a ratio shown in Table 1 below.

### (c) Formation of Conductive Polymer Layer

The application liquid was applied to a surface of the anode foil (a surface of a dielectric layer) with use of a gravure coater. Thereafter, drying was performed to form a conductive polymer layer on the surface of the anode foil (the surface of the dielectric layer). The drying was performed by heating the anode foil, to which the application liquid had been applied, at 125° C. for 5 minutes. Next, a conductive polymer layer was formed on another surface of the anode foil (a surface of another dielectric layer) using the same method. A mass ratio between the organic compound (C) and the conductive polymer component in the formed conductive polymer layers was determined using a method described later.

Conductive polymer layers were formed on both surfaces of the cathode foil using the same method as that used to form the conductive polymer layers on both surfaces of the anode foil. Also, conductive polymer layers were formed on the separator by applying the application liquid to the separator and then performing drying using the same method as that used to form the conductive polymer layers on both surfaces of the anode foil.

### (d) Production of Capacitor Element

The anode foil, the cathode foil, and the separator were each cut into a predetermined size. An anode lead tab and a cathode lead tab were connected to the anode foil and the cathode foil. Next, the anode foil and the cathode foil were wound with the separator disposed therebetween. An anode lead wire and a cathode lead wire were respectively connected to end portions of the lead tabs protruding from the wound body. Chemical conversion treatment was again performed on the obtained wound body to form a dielectric layer on edge surfaces of the anode foil. An end portion of an outer surface of the wound body was fixed with a winding end tape to obtain a capacitor element.

(e) Impregnation with Liquid Component

An electrolyte solution (liquid component) was prepared by dissolving o-phthalic acid and triethylamine (base component) at a total concentration of 25% by mass in ethylene glycol (solvent). The capacitor element was immersed in the electrolyte solution for 5 minutes in a reduced pressure atmosphere (40 kPa). Thus, the capacitor element (stacked body) was impregnated with the electrolyte solution.

### (f) Sealing of Capacitor Element

An electrolytic capacitor like that shown in FIG. 1 was produced by sealing the capacitor element impregnated with the electrolyte solution. Thereafter, aging was performed at 95° C. for 90 minutes while applying a voltage to the electrolytic capacitor. Thus, the electrolytic capacitor (capacitor A1) was obtained.

### (Capacitors A2 to A24 and C1)

Electrolytic capacitors (capacitors A2 to A24 and C1) were produced using the same method as that used to produce the capacitor A1, except that the composition of the application liquid was changed. The composition of the application liquid was changed as shown in Table 1 below. Specifically, the type of the organic compound (C) and/or proportions of the components were changed as shown in Table 1. Also, in the production of the capacitor A4, drying was performed at 135° C. for 30 minutes in the formation of the conductive polymer layers. The produced capacitors were evaluated using the following methods.

### Evaluation

The conductive polymer layers, the wound bodies, and the capacitors described above were evaluated using the following methods.

### (Amount of Organic Compound (C) Contained in Conductive Polymer Layer)

A ratio Wc/Wp between a mass Wc of the organic compound (C) remaining in a formed conductive polymer layer and a mass Wp of the conductive polymer component contained in the conductive polymer layer was determined.

The mass Wp can be calculated from a concentration of the conductive polymer component in the dispersion liquid (application liquid) containing the conductive polymer component, which was used to form the conductive polymer layer on the anode foil, and a mass of the dispersion liquid used to form the conductive polymer layer.

The mass Wc was calculated as follows. First, a mass W0 (initial value) of the capacitor element was measured after the dispersion liquid containing the conductive polymer component and the liquid medium (in this example, the organic compound (C) and water) was applied to the anode foil and before a portion of the liquid medium was removed from the applied dispersion liquid. Next, a mass W1 (after treatment) of the anode foil was measured after a portion of the liquid medium was removed. Then, the mass Wc can be calculated by obtaining a mass difference (W1−W0) between the mass W1 after treatment and the initial mass W0. It is thought that, in this example, almost all water contained in the dispersion liquid applied to the anode foil was removed in the drying step. Accordingly, the mass difference (W1−W0) was taken to be the mass Wc of the organic compound (C). Note that it is also possible to determine a mass Ww of water remaining in the conductive polymer layer using Karl Fischer titration, and take (W1−W0−Ww) to be Wc.

### (Adhesion Between Anode Foil and Separator)

The adhesion between the anode foil and the separator was evaluated using a peeling test machine.

### (Measurement of Equivalent Series Resistance and Leakage Current)

The equivalent series resistance (ESR) and a leakage current (LC) were measured for each of the initial electrolytic capacitors after the aging described above. Furthermore, the electrolytic capacitors were left to stand in an atmosphere at 145° C. for 1000 hours, and then the ESR and the leakage current were measured. The leakage current was measured by applying a rated voltage and measuring a current value after 120 seconds. The measurement was performed at 20° C.

Compositions of the application liquids used in the production of the electrolytic capacitors and evaluation results are shown in Tables 1 and 2. Note that “#200”, “#300”, “#400”, and “#2000” in Table 2 indicate that the weight average molecular weight was about 200, about 300, about 400, and about 2000, respectively.

TABLE 1

| | Composition of application liquid | | | | Evaluation result | | | | | |
|---|---|---|---|---|---|---|---|---|---|---|
| | Conductive | | Organic compound (C) | | | | | | After left at 145° C. | |
| | polymer | Water | | Content | | | Initial value | | for 1000 hours | |
| | component | [% by | | [% by | | | ESR | LC | ESR | LC |
| | [% by mass] | mass] | Type | mass] | Wc/Wp | Adhesion | (mΩ) | (μA) | (mΩ) | (μA) |
| C1 | 2.0 | 98 | Not added | 0 | 0 | Poor | 21.5 | 22.8 | 88.8 | 125.7 |
| A1 | 2.0 | 95 | Ethylene glycol | 3.0 | 1.2 | Fair | 15.4 | 8.8 | 41.5 | 55.3 |
| A2 | 2.0 | 93 | Ethylene glycol | 5.0 | 2.0 | Good | 11.5 | 4.5 | 17.8 | 6.6 |
| A3 | 2.0 | 88 | Ethylene glycol | 10 | 4.0 | Good | 9.9 | 3.8 | 13.2 | 4.5 |
| A4 | 2.0 | 88 | Ethylene glycol | 10 | 2.0 | Good | 11.6 | 4.1 | 18.0 | 7.1 |
| A5 | 2.0 | 83 | Ethylene glycol | 15 | 6.0 | Good | 10.5 | 3.7 | 14.1 | 4.3 |
| A6 | 2.0 | 78 | Ethylene glycol | 20 | 8.0 | Good | 11.3 | 3.7 | 15.8 | 4.5 |
| A7 | 2.0 | 73 | Ethylene glycol | 25 | 10 | Good | 11.8 | 3.6 | 16.2 | 4.5 |
| A8 | 2.0 | 68 | Ethylene glycol | 30 | 12 | Fair | 14.6 | 3.8 | 35.1 | 4.7 |

TABLE 2

| | Composition of application liquid | | | | Evaluation result | | | | | |
|---|---|---|---|---|---|---|---|---|---|---|
| | Conductive | | Organic compound (C) | | | | | | After left at 145° C. | |
| | polymer | Water | | Content | | | Initial value | | for 1000 hours | |
| | component | [% by | | [% by | | | ESR | LC | ESR | LC |
| | [% by mass] | mass] | Type | mass] | Wc/Wp | Adhesion | (mΩ) | (μA) | (mΩ) | (μA) |
| A9 | 2.0 | 88 | Diethylene glycol | 10 | 4.1 | Good | 9.6 | 3.6 | 13.3 | 4.5 |
| A10 | 2.0 | 88 | Triethylene glycol | 10 | 4.1 | Good | 9.5 | 3.5 | 13.2 | 4.4 |
| A11 | 2.0 | 88 | Polyethylene glycol #200 | 10 | 4.2 | Good | 9.5 | 3.5 | 12.9 | 4.7 |
| A12 | 2.0 | 88 | Polyethylene glycol #300 | 10 | 4.2 | Good | 9.4 | 3.4 | 12.2 | 4.2 |
| A13 | 2.0 | 88 | Polyethylene glycol #400 | 10 | 4.2 | Good | 9.4 | 3.5 | 12.6 | 4.5 |
| A14 | 2.0 | 88 | Polyoxyethylene | 10 | 4.3 | Good | 9.5 | 4.0 | 12.4 | 5.1 |
| | | | polyoxypropylene glycol | | | | | | | |
| | | | #2000 | | | | | | | |
| A15 | 2.0 | 88 | Sulfolane | 10 | 4.2 | Good | 9.4 | 4.1 | 12.8 | 5.3 |
| A16 | 2.0 | 88 | γ-butyrolactone | 10 | 3.5 | Good | 10.5 | 4.5 | 14.5 | 5.9 |
| A17 | 2.0 | 88 | Borate ester | 10 | 4.3 | Good | 9.5 | 4.4 | 12.6 | 6.1 |
| A18 | 2.0 | 88 | Glycerin | 10 | 4.0 | Good | 9.8 | 3.2 | 11.9 | 4.0 |
| A19 | 2.0 | 88 | Polyglycerin | 10 | 4.2 | Good | 10.2 | 3.6 | 12.8 | 4.3 |
| A20 | 2.0 | 88 | Mannitol | 10 | 4.0 | Good | 9.2 | 3.3 | 11.1 | 4.1 |
| A21 | 2.0 | 88 | Xylitol | 10 | 4.0 | Good | 9.6 | 3.8 | 12.1 | 4.8 |
| A22 | 2.0 | 88 | Sorbitol | 10 | 4.0 | Good | 9.2 | 3.4 | 11.4 | 4.2 |
| A23 | 2.0 | 88 | Erythritol | 10 | 4.1 | Good | 9.2 | 3.2 | 11.6 | 4.4 |
| A24 | 2.0 | 88 | Pentaerythritol | 10 | 4.4 | Good | 9.4 | 3.3 | 11.5 | 4.5 |

As shown in Tables 1 and 2, it is possible to improve the adhesion between the electrode foil and the separator and reduce the ESR and the leakage current by forming the conductive polymer layers such that the organic compound (C) remains in the conductive polymer layers. Particularly good results were obtained in cases where Wc/Wp was within a range from 2.0 to 10.

Reasons why the adhesion between the electrode foil and the separator improved due to the conductive polymer layers being formed such that the organic compound (C) remained in the conductive polymer layers are not clear, but may be conceivable as follows. The size of a mixed region in which the first conductive polymer layer formed on the electrode foil and the second conductive polymer layer formed on the separator are mixed increases due to the presence of the organic compound (C). It is conceivable that consequently, bonding strength between the electrode foil and the separator is increased and the adhesion therebetween is improved. Likewise, it is conceivable that the ESR decreases due to an increase in the size of the mixed region.

Also, it is conceivable that when the conductive polymer layers are formed such that the organic compound (C) remains in the conductive polymer layers, the liquid component (L) (e.g., an electrolyte solution) is likely to reach the surface of the dielectric layer. It is conceivable that consequently, the liquid component (L) functioned to form a dielectric layer (oxide film), thus reducing the leakage current.

### INDUSTRIAL APPLICABILITY

The present disclosure can be applied to electrolytic capacitors.

Although the present invention has been described with respect to a presently preferred embodiment, such disclosure should not be interpreted as limiting the present invention. Various modifications and alterations will undoubtedly become apparent to those skilled in the art to which the present invention pertains upon reading the above disclosure. Therefore, the appended claims should be interpreted to include all modifications and alterations without departing from the true spirit and scope of the present invention.

### REFERENCE SIGNS LIST

10: capacitor element, 11: anode foil, 12: cathode foil, 13: separator, 14: winding end tape, 100: electrolytic capacitor, 101: bottomed case, 102: sealing member, 103: base plate, 104A, 104B: lead wire, 105A, 105B: lead tab

1. An electrolytic capacitor comprising:
a stacked body including an anode foil having a dielectric layer formed on a surface thereof, a cathode foil, and a separator; and
a liquid component with which the stacked body is impregnated,
wherein the stacked body includes a conductive polymer layer that is formed on the separator and at least one surface selected from a surface of the dielectric layer and a surface of the cathode foil,
the conductive polymer layer includes a mixed region in which a first conductive polymer layer formed on the at least one surface and a second conductive polymer layer formed on the separator are mixed, and
an organic compound that does not boil at 100° C. under 1 atm is present in the conductive polymer layer.

2. The electrolytic capacitor according to claim 1,
wherein the organic compound includes at least one selected from the group consisting of polyhydric alcohols, sulfolane, γ-butyrolactone, and borate esters.

3. The electrolytic capacitor according to claim 1,
wherein the electrolytic capacitor contains, in the mixed region, at least one selected from the group consisting of glycols, glycerin, polyglycerins, and sugar alcohols.

4. A method for manufacturing an electrolytic capacitor that includes an anode foil having a dielectric layer formed on a surface thereof, a cathode foil, and a separator, the method comprising, in the following order:
a polymer layer formation step of forming a conductive polymer layer containing a conductive polymer component on the separator and at least one surface selected from a surface of the dielectric layer and a surface of the cathode foil;
a stacked body formation step of forming a stacked body including the conductive polymer layer by stacking the anode foil, the cathode foil, and the separator such that the separator is disposed between the anode foil and the cathode foil; and
an impregnation step of impregnating the stacked body with a liquid component,
wherein the polymer layer formation step includes:
a step (a) of applying an application liquid that contains the conductive polymer component and a liquid medium to the at least one surface and the separator; and
a step (b) of forming the conductive polymer layer on the at least one surface and the separator by removing a portion of the liquid medium from the applied application liquid,
the liquid medium includes water and an organic compound that does not boil at 100° C. under 1 atm, and
in the step (b), a portion of the liquid medium is removed such that the organic compound remains in the conductive polymer layer.

5. The method for manufacturing an electrolytic capacitor according to claim 4,
wherein the conductive polymer layer includes a first conductive polymer layer formed on the at least one surface and a second conductive polymer layer formed on the separator, and
the conductive polymer layer of the stacked body subjected to the impregnation step includes a mixed region in which the first conductive polymer layer and the second conductive polymer layer are mixed.

6. The method for manufacturing an electrolytic capacitor according to claim 4,
wherein a content of water in the application liquid is 40% by mass or more, and
the steps (a) and (b) are performed such that a mass of the organic compound contained in the conductive polymer layer is larger than a mass of water contained in the conductive polymer layer.

7. The method for manufacturing an electrolytic capacitor according to claim 4,
wherein the steps (a) and (b) are performed such that a ratio Wc/Wp between a mass Wc of the organic compound remaining in the conductive polymer layer and a mass Wp of the conductive polymer component contained in the conductive polymer layer is 1.0 or more and 20 or less.

8. The method for manufacturing an electrolytic capacitor according to claim 4,
wherein the organic compound includes at least one selected from the group consisting of polyhydric alcohols, sulfolane, γ-butyrolactone, and borate esters.

9. The method for manufacturing an electrolytic capacitor according to claim 4,
wherein the liquid component includes a protic solvent, and
the protic solvent includes at least one selected from the group consisting of glycols, glycerin, polyglycerins, and sugar alcohols.

10. The method for manufacturing an electrolytic capacitor according to claim 4,
wherein the liquid component is an electrolyte solution.

11. The method for manufacturing an electrolytic capacitor according to claim 4,
wherein the organic compound and the liquid component includes the same compound.

12. The method for manufacturing an electrolytic capacitor according to claim 4,
wherein the application liquid contains poly(3,4-ethylenedioxythiophene) and polystyrene sulfonic acid, and
the application liquid has a pH of 1.0 to 6.0.

13. The method for manufacturing an electrolytic capacitor according to claim 4,
wherein, in the step (b), a portion of the liquid medium is removed by heating the applied application liquid at a temperature higher than or equal to 100° C.

14. The method for manufacturing an electrolytic capacitor according to claim 4,
wherein, in the polymer layer formation step, the conductive polymer layer is formed on the surface of the dielectric layer, the surface of the cathode foil, and the separator.

15. The method for manufacturing an electrolytic capacitor according to claim 4,
wherein the stacked body is a wound body, and
in the stacked body formation step, the wound body is formed by winding the anode foil, the cathode foil, and the separator such that the separator is disposed between the anode foil and the cathode foil.

16. The method for manufacturing an electrolytic capacitor according to claim 4,
wherein the organic compound is a first organic compound, and
the method further comprises, after the stacked body formation step and before the impregnation step:
a step of impregnating the conductive polymer layer in the stacked body with a liquid that contains water as a major component and a second organic compound that does not boil at 100° C. under 1 atm; and
a step of removing a portion of the liquid with which the conductive polymer layer has been impregnated, such that a mass of the second organic compound contained in the conductive polymer layer is larger than a mass of water contained in the conductive polymer layer.
